(19) United States
(12) Patent Application Publication
(10) Pub. No.: US 2002/0063493 A1
(43) Pub. Date: May 30, 2002

(54) Rotary electric machine having excellent insulation

(75) Inventors: Akifumi Hosoya, Anjo-city (JP); Yasuyuki Wakahara, Kariya-city (JP); Masami Niimi, Kariya-city (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 09/987,412

(22) Filed: Nov. 14, 2001

(30) Foreign Application Priority Data
Nov. 30, 2000 (JP) 2000-365160

(51) Int. Cl. H02K 1/22; H02K 5/10

(52) U.S. Cl. 310/261; 310/236

(57) ABSTRACT

An armature is constructed by installing a lower layer coil and an upper layer coil in double layers in each slot provided on an armature core. A straight portion of the upper layer coil installed in the slot includes coil end portions at both side ends, which protrude from both axial end surfaces of the armature core in an axial direction. A liquid resin is filled in an inner groove defined among adjacent coil end portions in a peripheral direction, the axial end surface of the armature core and an outer insulating plate. Also, a cylindrical body (non-magnetic material) is mounted on an outer periphery of the coil end portions. Accordingly, brush powder is restricted from entering the inner groove, and a creeping distance for insulation between the armature core, the lower layer coil, and the upper layer coil can be secured.

### CROSS REFERENCE TO RELATED APPLICATION

The present application relates to and incorporates herein by reference Japanese Patent Application No. 2000-365160 filed on Nov. 30, 2000.

### BACKGROUND OF THE INVENTION

The present invention relates to a rotary electric machine having an armature which is constructed by installing a lower layer coil and an upper layer coil in double layers in each slot against an armature core.

In a rotary electric machine disclosed in JP-A-8-140324, as shown in FIG. 5, an armature is constructed by installing a pair of a lower layer coil 120 and an upper layer coil 130 formed in generally U-shape in double layers in each slot 100 provided on an armature core 110. Cylindrical bodies 140 are mounted on outer peripheries of both axial side portions (coil end portions) of the upper layer coil 130 to restrict the upper layer coil 130 from expanding outward in the radial direction due to centrifugal force when the armature turns at high speed. Thus, strength against centrifugal force is increased.

In this armature, however, since a commutator is composed of one side of arm portions 131 of the upper layer coils 130 as commutator segments, abraded powder (brush powder) of brushes 150 is likely to enter gaps which are provided for insulation and are defined between the armature core 110 and the coils 120, 130 and between the coil 120 and the coil 130. Accordingly, insulation is lessened due to entering of brush powder.

Also, it is proposed that insulation between the core and the coils and between the coils is secured by applying liquid resin from outer periphery to entirely cover the coil after mounting the cylindrical body. However, a large amount of resin is necessitated. Further, a cutting process for removing resin flown out to the commutator is required at a brush sliding surface (end surface of arm portion of the upper layer coil). Also, an undercutting process for forming a groove between adjacent commutator segments in the peripheral direction is required. Specially, when an external form of the segment has a curved line, the undercutting process becomes complicated.

### SUMMARY OF THE INVENTION

It is an object of the present invention to provide a rotary electric machine having strength against centrifugal force and excellent insulation, in which an amount of resin is reduced and a resin removing process (cutting process and undercutting process) is not required.

According to the present invention, an armature is constructed by installing a pair of a lower layer coil and an upper layer coil in double layers in each slot provided on an armature core. A cylindrical body is mounted for circumferentially surrounding an outer periphery of the coil end portions which locate axially outside of the end surface of the armature core. Resin insulator is filled in an inner groove defined among coil end portions arranged adjacently in a peripheral direction, an axial end surface of an armature core and an insulating plate.

Therefore, entering of brush powder is restricted and creeping distances for insulation between the armature core, lower layer coils and upper layer coils are secured. Further, the resin insulator is filled only in the inner grooves so that a resin amount is rather reduced as compared with covering the coil entirely with resin. Moreover, there is no needless resin so that the cutting process of the resin is not required.

In addition, the cylindrical body is fixed at the same time as hardening the resin insulator so that the cylindrical body is restricted from dropping out of the coil end portions.

### BRIEF DESCRIPTION OF THE DRAWINGS

Other objects, features and advantages of the present invention will become more apparent from the following detailed description made with reference to the accompanying drawings.

In the drawings:

FIG. 1 is a cross-sectional view of a rotary electric machine according to an embodiment of the present invention;

FIG. 2 is a perspective view showing a main part of an armature in which resin is filled;

FIG. 3A is a cross-sectional view, in which a cylindrical body is provided without protruding from a surface of an outer insulating plate in an axial direction, and FIG. 3B is a cross-sectional view, in which the cylindrical body overlaps an upper layer coil arm portion;

FIG. 4 is a cross-sectional view taken along line IV-IV of FIG. 1; and

FIG. 5 is a cross-sectional view of a conventional rotary electric machine.

### DETAILED DESCRIPTION OF PREFERRED EMBODIMENTS

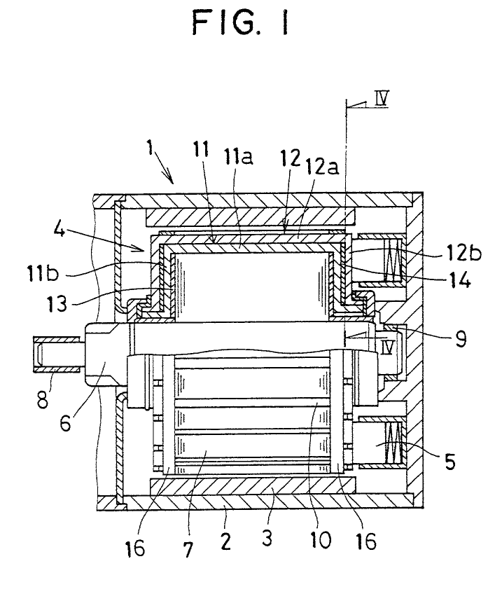

A rotary electric machine 1 is, for example, used as a starting motor of a starter for starting a vehicle engine. As shown in FIG. 1, the rotary electric machine 1 is constructed of a magnetic field unit (stator) composed of a yoke 2 and a fixed magnetic pole 3, an armature 4 (rotor), brushes 5 for sliding in contact with a commutator (described hereinafter) provided on the armature 4, and the like.

The armature 4 is constructed of a rotation shaft 6, an armature core 7, armature coils (described hereinafter), and the like. The rotation shaft 6 is rotatably supported by bearings 8 and 9 at both axial side ends thereof.

The armature core 7 is constructed by laminating a plurality of core plates (not shown) and press-fitted to an outer periphery of the rotation shaft 6. A predetermined number (e.g. twenty-five) of slots 10 are formed on the armature core 7 in such a manner that recessed portions formed on an outer periphery of each core plate are arranged in lines in the axial direction of the armature core 7.

The armature coil is composed of a predetermined number of lower layer coils 11 and upper layer coils 12. Each of the upper and lower layer coils 11 and 12 are layered in double and installed in each slot 10 with respect to the armature core 7. Both axial end portions of coils 11 and 12 are sequentially combined together to form the armature coil by welding, for instance.

The lower layer coil 11 includes a coil straight portion (lower layer coil straight portion) 11a and a pair of coil arm portions (lower layer coil arm portions) 11b. The lower layer coil straight portion 11a is in a straight-shape and slightly longer than a full length of the slot 10 (full length of the armature core 7). The lower layer coil arm portions 11b are formed by bending the lower layer coil 11 at both axial side ends of the lower layer coil straight portion 11a so as to be generally perpendicular to the straight portion 11a. The lower layer coil straight portion 11a is installed in the slot 10 through insulating paper (not shown). Both of the arm portions 11b of the lower layer coil 11 are arranged at both axial side ends of the armature core 7 through a disk-shaped inner insulating plate 13, respectively.

The upper layer coil 12 includes a coil straight portion (upper layer coil straight portion) 12a and a pair of coil arm portions (upper layer coil arm portions) 12b. The upper layer coil straight portion 12a is in a straight-shape and slightly longer than the lower layer coil straight portion 11a. The upper layer coil arm portions 12b are provided by bending the upper layer coil 12 at both axial side ends of the upper layer coil straight portion 12a so as to be generally perpendicular to the straight portion 12a. The upper layer coil straight portion 12a is installed in the slot 10 on radially outside of the lower layer coil straight portion 11a through insulating paper (not shown). Both of the arm portions 12b of the upper layer coil 12 are arranged axially outside of both of the arm portions 11b of the lower layer coil 11 through a disk-shaped outer insulating plate 14, respectively.

A commutator is composed of one side (right side in FIG. 1) of the upper layer coil arm portions 12b as commutator segments, and an axial end surface of the same arm portion 12b forms a brush slide-contacting surface.

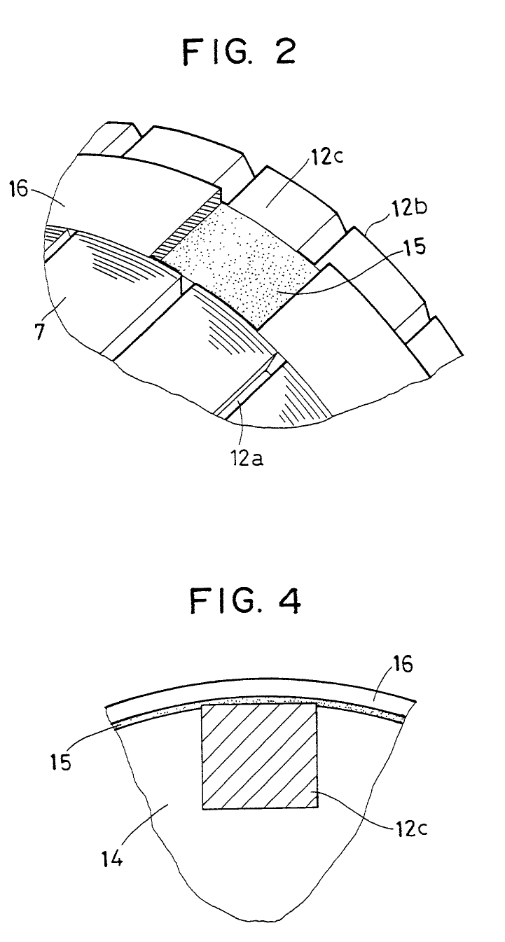

In the above armature 4, as shown in FIG. 2 in which the cylindrical body 16 is shown only partly, a part of the upper layer coil straight portion 12a installed in the slot 10 is protruded from the end surface of the armature core 7 in the axial direction to form a coil end portion 12c. A liquid resin 15 is filled in an inner groove defined among coil end portions 12c adjacently arranged in a peripheral direction, the axial end surface of the armature core 7 and the outer insulating plate 14. Further, a cylindrical body 16 made of a non-magnetic material is mounted on the outer periphery of the coil end portions 12c.

The cylindrical body 16 is mounted after filling the liquid resin 15 in the inner groove, but before hardening of the resin 15 so that the cylindrical body 16 is fixed in accordance with hardening of the resin 15 which provides a resin insulator.

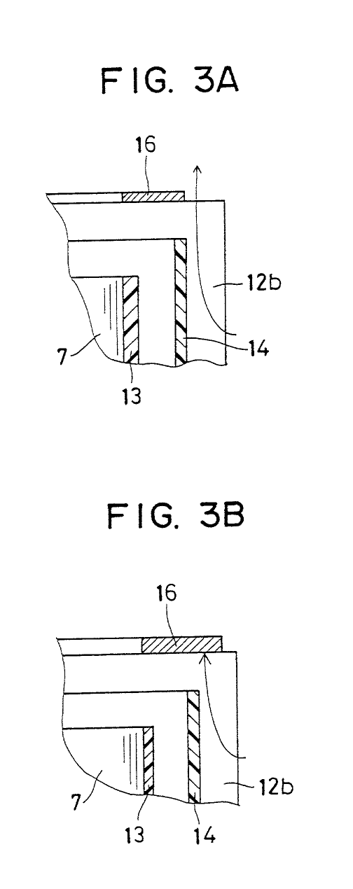

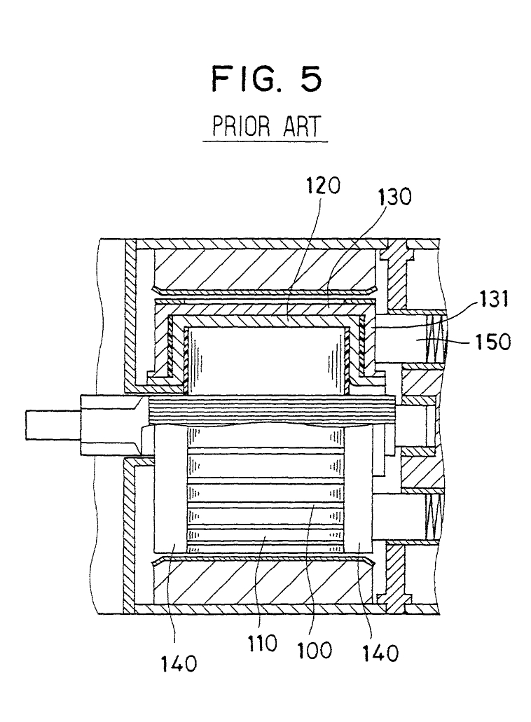

Further, as shown in FIG. 3A, the width of the cylindrical body 16 in the axial direction is generally equal to the axial distance from the axial end surface of the armature core 7 to the surface of the outer insulating plate 14 opposing the upper layer coil arm portion 12b. Also, the cylindrical body 16 is mounted not to overlap the upper layer coil arm portions 12b without exceeding the outer insulating plate 14 in the axial direction.

Next, effects of the present embodiment is described.

In the armature 4 of the present embodiment, the commutator is composed of the upper layer coil arm portions 12b as commutator segments. Therefore, there is a possibility that abraded powder of the brushes 5 (brush powder) enters a part where insulation of the armature 4 is required, especially, between the armature core 7 and the lower layer coil 11, between the armature core 7 and the upper layer coil 12, and between the lower layer coil 11 and the upper layer coil 12. However, the resin 15 is filled in the inner groove defined among the coil end portions 12c which are adjacently arranged in the peripheral direction, and the axial end surface of the armature coil 7 and the outer insulating plate 14. Therefore, entering of the brush powder is restricted. Moreover, creeping distances for insulation between the armature coil 7 and the lower layer coil 11, between the armature coil 7 and the upper layer coil 12, and between the lower layer coil 11 and the upper layer coil 12 are secured.

If the cylindrical body 16 is mounted on the coil end portions 12c without filling the resin 15, a small clearance remains among the inner peripheral surface of the cylindrical body 16, the outer peripheral surface of the coil end portion 12c, and the outer peripheral surface of the outer insulating plate 14. However, since the cylindrical body 16 is mounted after filling the resin 15 in the inner groove, a part of the resin 15 can flow in the radial direction and fill up the clearance so as to provide a resin layer, as shown in FIG. 4.

As a result, since the clearance or the inner groove where the brush powder may easily enter can be filled up with the resin 15, the creeping distances for insulation between the armature coil 7 and the lower layer coil 11, between the armature coil 7 and the upper layer coil 12, and between the lower layer coil 11 and the upper layer coil 12 can be secured. Therefore,the armature 4 secures excellent insulation.

Further, since a part where the resin 15 is filled in is limited to the above inner groove, a resin amount is reduced as compared with a case that the coil is entirely covered with the resin 15. Moreover,product cost can be decreased. Since the outer insulating plate 14 is disposed axially outside of the inner groove between adjacent coil end portions 12c, that is, a groove between the upper layer coils 12 is partitioned into the inner groove and an outer groove in the axial direction, the resin 15 filled in the inner groove is restricted from flowing out to the outer groove at the commutator side. Therefore, an undercutting process between the adjacent commutator segments is not required so that the product cost can be decreased.

The cylindrical body 16 is mounted on before hardening of the resin 15 so that the cylindrical body 16 is fixed at the same time as hardening the resin 15. Thus, the cylindrical body 16 is restricted from dropping out of the coil end portions 12c.

Further, the cylindrical body 16 mounted on the outer periphery of the coil end portions 12c can absorb expansion of the upper layer coil 12 in the radially outward due to the centrifugal force. Thus, strength against the centrifugal force is secured, thereby having durability even at the high speed rotation. Moreover, the upper layer coil 12 is restricted from moving by mounting the cylindrical body 16 so that each commutator segment (the upper layer coil arm portion 12b) composing the commutator is accurately positioned. Furthermore, the armature 4 can last longer.

When the cylindrical body 16 is mounted on the outer periphery of the coil end portions 12c, as shown in FIG. 3B, if the cylindrical body 16 protrudes from the outer insulating plate 14 in the axial direction, the brush powder entered the outer grooves defined between adjacent commutator segments in the peripheral direction can not easily leave from the outer grooves due to the cylindrical body 16. As a result, the brush powder stays in the outer grooves defined between the commutator segments.

However, in the armature 4 of the present embodiment, as shown in FIG. 3A, the cylindrical body 16 is provided without protruding from the outer insulating plate 14 and without overlapping the upper layer coil arm portion 12b in the axial direction. In this structure, even if the brush powder enters the outer grooves defined between the adjacent commutator segments, the brush powder can leave out in a radial direction. Accordingly, staying of the brush powder between the commutator segments is decreased so that the insulation inside the armature is restricted from lessening due to entering of the brush powder.

The present invention should not be limited to the disclosed embodiments, but may be implemented in other ways without departing from the spirit of the invention.

What is claimed is:

1. A rotary electric machine comprising:
an armature core having a predetermined number of slots;
an armature coil having a predetermined number of lower layer coils and upper layer coils installed in double layers in each of the slots against the armature core, the lower layer coils and the upper layer coils each having a straight portion and an arm portion bent perpendicularly from the straight portion;
an insulating plate interposed for insulation between the arm portion of the lower layer coil and the arm portion of the upper layer coil which are provided axially outside of an axial end surface of the armature core;
a cylindrical body circularly surrounding an outer periphery of a coil end portion of the upper layer coil, the coil end portion locating axially outside of the axial end surface of the armature core and excluding the arm portion of the upper layer coil; and
a resin insulator filled in an inner groove among adjacent coil end portions in a peripheral direction, the axial end surface of the armature core and the insulating plate.

2. The rotary electric machine as in claim 1, wherein the cylindrical body is fixed to the armature core with the resin insulator.

3. The rotary electric machine as in claim 1, wherein the arm portions of the upper layer coils construct commutator segments of a commutator.

4. The rotary electric machine as in claim 1, wherein the cylindrical body is mounted without protruding in an axial direction from a surface of the insulating plate which faces the arm portion of the upper layer coil.

5. The rotary electric machine as in claim 4, wherein the resin insulator is provided only underneath the cylindrical body.

6. The rotary electric machine as in claim 1, wherein the cylindrical body is fixed in accordance with hardening of resin which is filled to provide the resin insulator.

7. The rotary electric machine as in claim 1, wherein the cylindrical body is made of non-magnetic material.

8. The rotary electric machine as in claim 1, wherein:
the resin insulator is formed by filling a liquid resin in the inner groove for insulating the cylindrical body; and
mounting the cylindrical body after filling the liquid resin and before the liquid resin hardens.
